(19) United States
(12) Patent Application Publication
(10) Pub. No.: US 2008/0276748 A1
(43) Pub. Date: Nov. 13, 2008

(54) Gear Shifter

(76) Inventor: Bo-Cheng Chen, San-Chong City (TW)

Correspondence Address: LIN & ASSOCIATES INTELLECTUAL PROPERTY, INC., P.O. BOX 2339, SARATOGA, CA, 95070-0339, US

(21) Appl. No.: 11/745,630

(22) Filed: May 8, 2007

(51) Int. Cl. F16C 1/10

(52) U.S. Cl. 74/502.2

(57) ABSTRACT

Gear shifter includes base plate having a bolt shaft which is in turn fitted in with a detent ring, a pawl, a lever, and a plate member. The detent ring is provided with interior space whose inner circumferential surface is formed with a series of first and second ratchet teeth. Side wall of the pawl is disposed with first catch tongue and second catch member. Lever is formed with movable ratchets engaged with second ratchet tooth. When user triggers the lever towards first direction, the movable ratchet is to actuate detent ring to rotate, and using the first catch tongue to abut against the first ratchet teeth, thus cable is pulled tightly wound. When the lever is triggered towards second direction, the lever will push the first catch tongue to disengage from abutting against the first ratchet tooth, thus making the detent ring rotating back to release the tight cable.

### BACKGROUND OF THE INVENTION

1. Field of the Invention

The present invention is generally related to a gear shifter, and in particular, to a gear shifter used for actuating and controlling the derailleur of a bicycle.

2. The Prior Arts

Traditional bicycle with gear shifting capability is generally mounted with a gear shifter located near the placement of a handle grip, thereby facilitating the rider to operate the gear shifter to make the chain to be shifted to another sprocket gear, thus achieving the objective of changing speed.

Nowadays, many kinds of speed change devices used on the bicycles appear on the market, but they mostly have the disadvantages of having complicated structures and higher manufacturing cost.

### SUMMARY OF THE INVENTION

A primary objective of the present invention is to provide a bicycle gear shifter having simpler structure and lower cost.

The main feature of the present invention is as follows: by triggering a lever to control the gear shifting. In other words, when the lever is rotated to a first direction, the cable is tightened accordingly, and thereby actuating the swing member by means of the chain to be guided to a specified direction so that the chain will be shifted to one of the sprocket gears on the multi sprocket chainwheel; and when the lever is rotated to a second direction, the cable is loosened; and the swing member is guided by means of the chain to another specified direction so that the chain will be shifted to another sprocket gear on the multi sprocket chainwheel. Hence, the speed changing can be controlled.

The gear shifter according to the present invention includes a base plate having a bolt shaft as the central shaft which is in turn to be fitted in with a detent ring, a pawl, a lever, and a plate member. The detent ring is provided with an interior space which is concaved axially, and includes an inner circumferential surface formed with a series of first ratchet teeth and a series of second ratchet teeth located at different positions thereof. The pawl cannot rotate relative with respect to the central shaft, and the side wall of the pawl is pivotly disposed with a first ratchet tooth engaged with a first catch tongue and a second catch member. The lever is formed with a movable ratchet engaged with the second ratchet teeth; and the lever is able to rotate relative with respect to the central shaft. The plate member is integrated with the lever, and an elastic unit is disposed between the plate member and the lever. When the user rotates the lever to a first direction, the movable ratchet is to actuate the detent ring to rotate, and at the same time, preventing the detent ring from rotating in reverse direction by using the first catch tongue abutted against the first ratchet tooth, hence, the cable is pulled tightly to be wound in the winding groove. When the lever is rotated to a second direction, the lever will push the first catch tongue to disengage from abutting against the first ratchet tooth, thus making the detent ring to rotate in reverse direction to release the tight cable, and at the same time, pushing the second catch member to be abutted against the first ratchet tooth for preventing the detent ring from reverting back to the original position in one action.

The present invention is able to adopt the bolt shaft as the central shaft of the base plate, and the detent ring can be provided with an engaging hole for cooperatively engaging with the bolt shaft, thereby making the detent ring to pass through the central shaft, but is unable to rotate relatively around it.

The first catch tongue, according to the present invention, is mainly used to keep the detent ring from rotating in the reverse direction when the detent ring is rotated towards the first direction. Therefore, a preferred embodiment of the first catch tongue has a bent body shape. The first end of the bent-shaped catch tongue is pressed or abutted against the first ratchet tooth of the detent ring for preventing the detent ring from rotating in the reverse direction; and when the detent ring needs to rotate in the reverse direction, the second end of the bent-shaped catch tongue is pushed, thus making the first end to disengage from abutting against of the first ratchet tooth; and the elasticity of the elastic unit is to cause the detent ring to rotate in the reverse direction.

In order to prevent the detent ring from rotating back to the original position instantaneously, the second catch member, according to the present invention, is to provide an intermittent stopping function, that is, the second catch member is to immediately abut against the first ratchet tooth at the time when the first end of the first catch tongue is disengaged from the first ratchet tooth.

Compared with the prior art, the present invention has a simpler structure and lower cost, as well as having more precise control of the gear shifting.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view showing the assembly of a plurality of elements of a gear shifter according to the present invention;

FIG. 2 is a perspective view showing a gear shifter according to an embodiment of the present invention;

FIG. 3 is a cross-sectional side plan view showing the embodiment of the gear shifter in accordance with the present invention;

FIG. 4A is a plan view showing the configuration of a lever and an elastic unit constructed in accordance with the embodiment of the present invention;

FIG. 4B is an operational view of FIG. 4A;

FIG. 5A is a plan view showing the actuating and stopping structures of the gear shifter constructed in accordance with the embodiment of the present invention;

FIG. 5B is an operational plan view showing the rotating of the lever to a first direction to drive the detent ring to rotate to the first direction, according to the embodiment of the present invention;

FIG. 6A is a schematic plan view showing the lever rotating to the first direction all the way to the highest gear, and is then reverted to its original position, according to the embodiment of the present invention;

FIG. 6B is a schematic plan view showing the lever rotating to the second direction, for releasing a detent ring to rotate to the second direction, according to the embodiment of the present invention;

FIG. 7 is a schematic view showing the gear shifter mounted on the handlebar of a conventional bicycle, according to the embodiment of the present invention; and

FIG. 8 is a schematic view showing the gear shifter mounted on the handlebar of a racing bicycle, according to the embodiment of the present invention.

### DETAILED DESCRIPTION OF THE PREFERRED EMBODIMENT

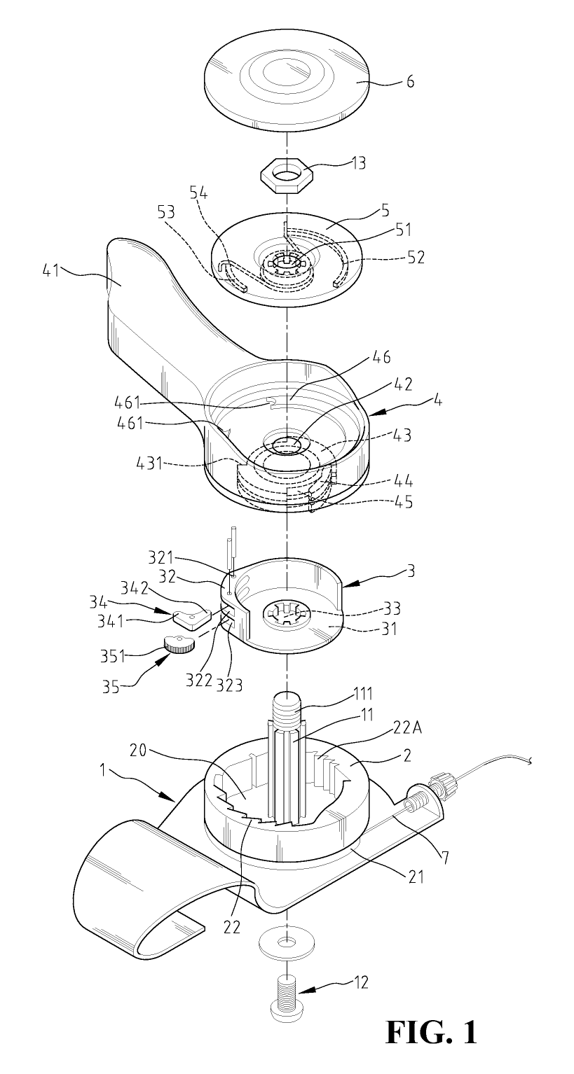

Referring to FIG. 1, the gear shifter according to the present invention comprises a base plate 1, a detent ring 2, a pawl 3, a lever 4 and a plate member 5. The base plate 1, used for fixing the gear shifter onto the frame of the handlebar, comprises a central shaft 11, whose preferred embodiment is a bolt shaft 11. The end of the central shaft 1 is formed with an external screw thread 111 of an appropriate length.

A preferred embodiment of the detent ring 2 is of a round body having a winding groove 21 on one end used for winding up a cable 7. An end of the detent ring 2 is provided with an interior space 20, which is concaved axially, and whose inner circumferential surface is formed with a series of first ratchet teeth 22 and a series of second ratchet teeth 22A located at different positions thereof. The detent ring 2 is sleeved onto the base plate 1, while making the central shaft 11 passing through the center of the detent ring 2.

A preferred embodiment of the pawl 3 is that it is formed with an axially-extended side wall 32. Some appropriate locations of the side wall 32 has a larger thickness on which a first slot hole 322 and a second slot hole 323 located below the first slot hole 322 are set, and a pair of pivot holes 321 parallel to the central shaft of the pawl 3 are set on the side wall; a first catch tongue 34 and a second catch member 35 are pivotly disposed in the first slot hole 322 and the second slot hole 323, respectively; and the center of the pawl 3 can be provided with a engaging hole 33 corresponding to the bolt shaft 11; a preferred embodiment of the first catch tongue 34 is of a bent-shaped disposed in the first slot hole 322. When a pivot shaft is inserted into the pivot hole 321, the first end 341 and the second end 342 of the bent-shaped first catch tongue 34 are revealed at the surfaces along the inner and the outer circumference of the side wall 32. A preferred embodiment of the second catch member 35 is of a fan-shaped body whose arc surface is formed with a plurality of teeth 351. When the fan-shaped body is placed into the second slot hole 323, another pivot shaft is pivotally-connected to the other pivot hole 321, making the arc surface of the fan-shaped body exposed at the surface along the outer circumference of the side wall 32. The pawl 3 is pivotly connected with the first catch tongue 34 and the second catch member 35, and the pawl 3 is disposed in the interior space 20 of the detent ring 2, thus making the first end 341 of the first catch tongue 34 and the teeth 351 of the second catch member 35 corresponding to the first ratchet teeth 22.

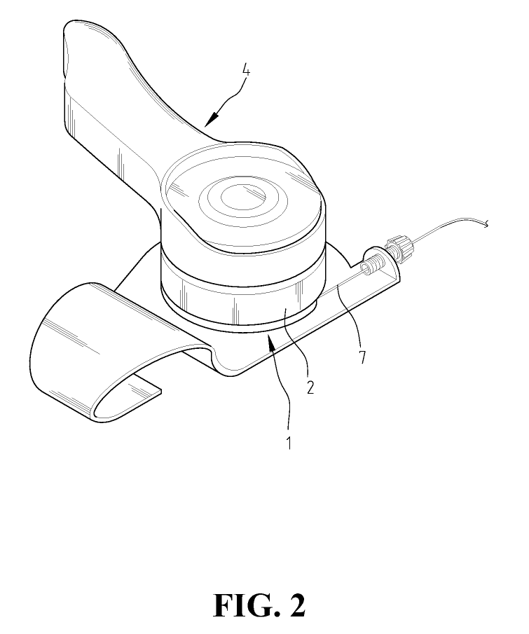

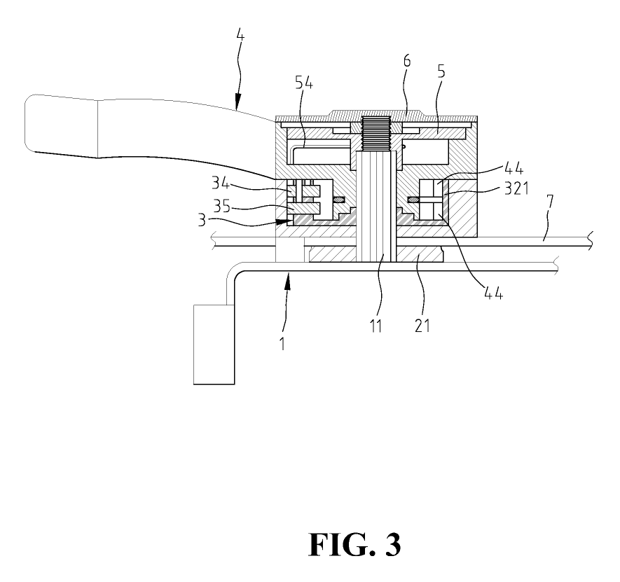

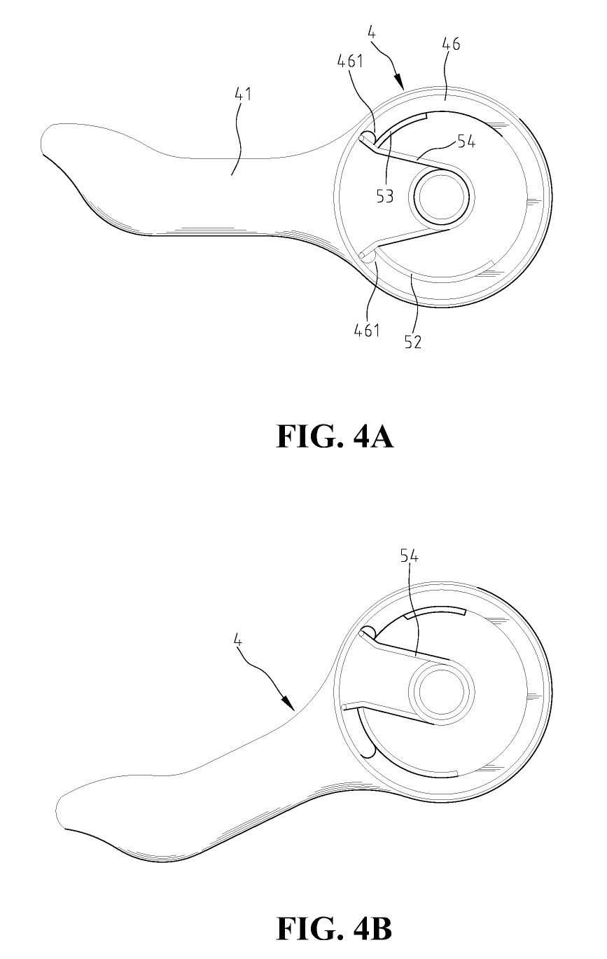

One end of the lever 4 is formed with a trigger portion 41, and the other end is formed with a center hole 42. The end face having the center hole 42 is provided with a flange 43 pivotly coupled with a movable ratchet 44, and formed with a spring coil 45 circled around the circumference of the flange 43. The spring 45 retains the movable ratchet 44 in the flange 43, as well as making the ratchet 44 to push towards the outer circumferential direction; the other end face of the lever 4 relative to the end face where the flange 43 is residing is formed in a concaved cavity, whose base face is formed with a discontinuous ring 46 comprising of two ends 461. The concaved cavity of the lever 4 is covered by the aforementioned plate member 5. A preferred embodiment of the plate member 5 is that its center is formed with a bolt hole 51 corresponding to the aforementioned bolt shaft 11. One side of the plate member 5 is formed with a first raised strip 52 and a second raised strip 53; and one side of the plate member 5 is formed with an elastic unit whose preferred embodiment is a torsion spring 54. Both ends of the torsion spring 54 are pressed against the ends of the first raised strip 52 and the second raised strip 53, respectively (shown in FIG. 4A). Therefore, when the trigger portion 41 is rotated to the first direction or the second direction which is opposite the first direction, the end 461 of the discontinuous ring 46 of the lever 4 is to compress the torsion spring 54 (shown in FIG. 4B) to make the torsion spring 54 to store elastic energy, which then is used for actuating the lever 4 to return to its original position when the lever 4 is let go. The plate member 5 covers the concaved cavity of the lever 4; and the screw cap 13 is screw-fastened to the external screw thread 111 after the bolt shaft 11 is passed through the bolt hole 51. Finally, a cover plate 6 is covered on the plate member 5 for completing the assembling of the gear shifter (shown in FIGS. 2 and 3).

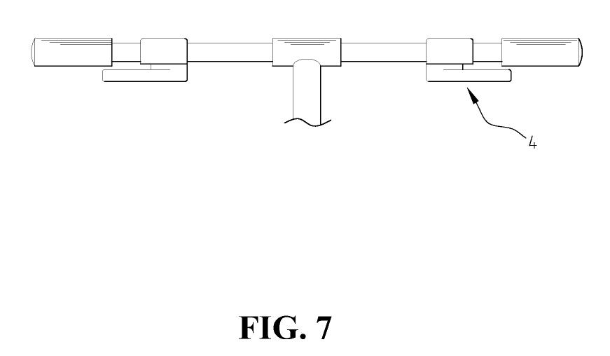

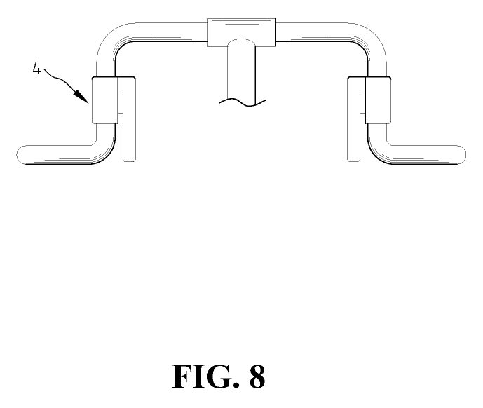

The gear shifter according to the present invention can be mounted on the frame of the handlebar of a conventional bicycle or a racing bicycle (shown in FIGS. 7 and 8). The operational descriptions of the present invention will be provided below.

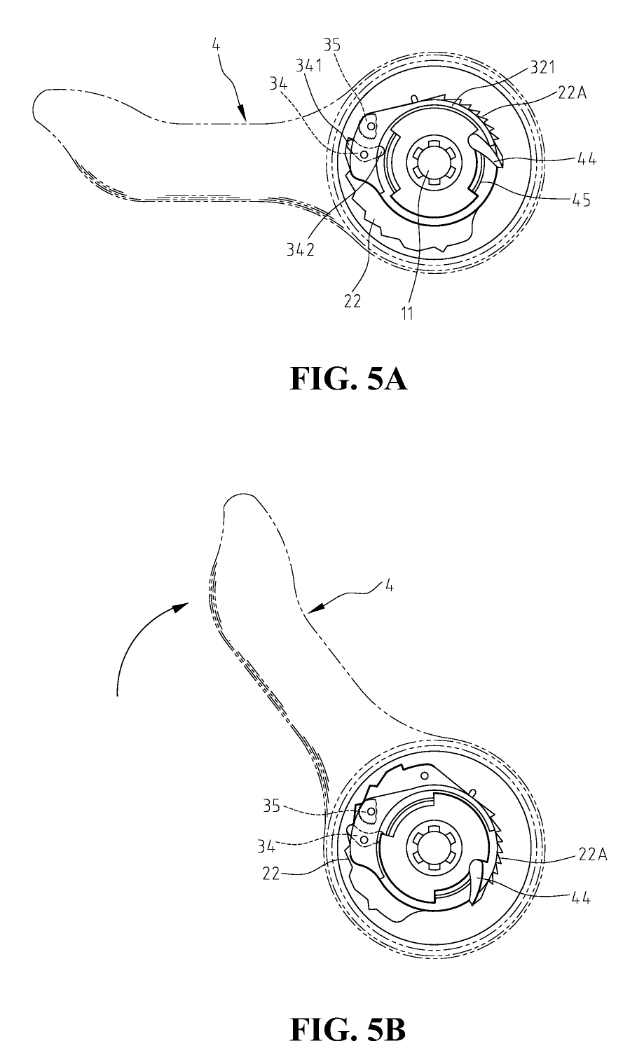

FIG. 5A is a plan view showing the gear shifter constructed in accordance with the present invention. Referring to FIG. 5A, the first catch tongue 34 and the second catch member 35 are simultaneously pressed against the first ratchet tooth 22 of the detent ring 2, under the condition of not having any outer force acting upon the lever 4. FIG. 5B shows when the lever 4 is rotated to the first direction, the movable ratchet 44 will push the second ratchet tooth 22A to make the detent ring to rotate a specific angle. Hence, the cable 7 will be pulled tighter for winding in the winding groove 21 to guide the swing member of the chain, whereby the chain is in turn to be shifted to a higher gear on the multi sprocket chainwheel. After the movable ratchet 44 pushes the second ratchet tooth 22A to rotate at the specific angle, the user has to release or let go the lever 4 for allowing the torsion spring 54 to restore the movable ratchet 44 back to its original position using the stored elastic energy, and ready for the next turn; during the process of reverting back to the original position of the movable ratchet 44, the first end 341 of the first catch tongue 34 is pressed or abutted against one of the first ratchet teeth 22 for preventing the detent ring from rotating backwards as the lever 4 is reverted back to its original position as caused by the friction force of the movable ratchet 44.

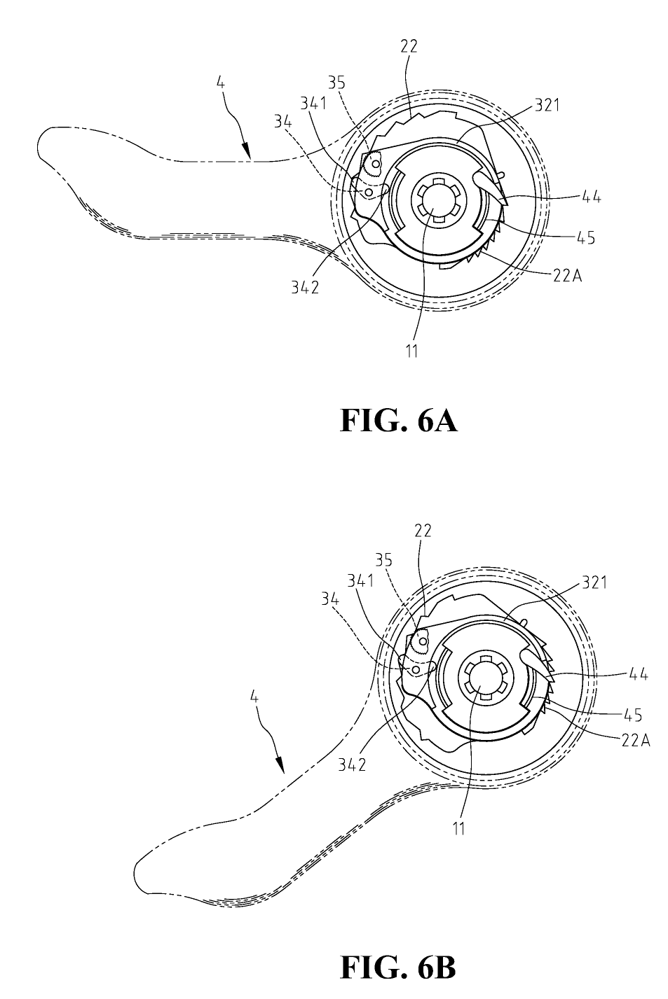

FIG. 6A shows the gear shifter, according to the present invention, being shifted to the highest gear. Here, the first end 341 of the first catch tongue 34 is pressed against one of the first ratchet teeth 22 to prevent the detent ring from rotating backwards. FIG. 6B shows the gear shifter shifting from the higher gear to the lower gear, when the user has to rotate the lever 4 to the second direction, thereby making an end 431 of the flange 43 which is disposed on the lever 4 in turn to push the second catch member 35 and the second end 342 of the first catch tongue 34. Thus the teeth 351 of the second catch member 35 are pressed against the first ratchet tooth 22; and the first end 341 of the first catch tongue 34 is to rotate due to the pushing force imposed on the second end 342, thereby disengaging the abutting of the first ratchet tooth 22; at this time, the tight cable 7 which is wound in the detent ring 2 begins to be released to let the detent ring 2 rotate back until to its original shift gear, in which every turn of the lever 4 will make the lever to turn at a specific angle.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A gear shifter, comprising:
a base plate, having a central shaft;
a detent ring, comprising a circular winding groove and is provided with an interior space wherein concaved axially and is comprised of an inner circumferential surface formed with a series of first ratchet teeth and a series of second ratchet teeth disposed at a plurality of different positions thereof, and the central shaft is passed through the center of the detent ring;
a cable, wound around in the winding groove of the detent ring;
a pawl, received in the interior space of the detent ring, and is combined to the central shaft thereby making the pawl unable to rotate relative to the central shaft, and the pawl is formed with a side wall extended axially, and the side wall is pivotly disposed with a first catch tongue and a second catch member, the first catch tongue comprising a first end and a second end configured at a plurality of different positions thereof, and the first end and the second end are protruded out of the outer circumferential surface and the inner circumferential surface of the side wall, respectively, and the second catch member is protruded out of the outer circumferential surface of the side wall;
a lever, pivotly disposed with a movable ratchet, and is combined with a spring, and the spring actuating the movable ratchet to move towards the outer circumferential direction;
a plate member, fixed on the central shaft, and assembled onto the lever, and the plate member is able to rotate relative to the lever;
an elastic unit, combined to the plate member for providing elasticity for the lever to return to an original position after rotation.

2. The gear shifter as claimed in claim 1, wherein the central shaft is a bolt shaft, and the center of the detent ring is an engaging hole for cooperatively engaging with the bolt shaft.

3. The gear shifter as claimed in claim 2, wherein the first catch tongue is bent-shaped.

4. The gear shifter as claimed in claim 3, wherein the second catch member is fan-shaped, and the arched surface is formed with a plurality of teeth.

5. The gear shifter as claimed in claim 4, wherein the side wall of the pawl is formed with a first slot hole and a second slot hole configured at a plurality of different heights thereof, and the first catch tongue and the second catch member are pivotly disposed in the first slot hole and the second slot hole, respectively.

6. The gear shifter as claimed in claim 1, wherein the axial end face of the lever is formed with a flange, and the movable ratchet is pivotly disposed to the flange, and the flange is coupled to a spring coil, and whereby the spring coil retaining the movable ratchet in the flange.

7. The gear shifter as claimed in claim 1, wherein the center of the plate member is formed with a bolt hole corresponding with the bolt shaft, and the end face of the plate member is formed with a first raised strip and a second raised strip configured at a plurality of different positions, and the elastic unit is a torsion spring disposed at the end face of the plate member, and each end of the torsion spring is pressed against the ends of the first raised strip and the second raised strip, respectively.
